(19) United States
(12) Patent Application Publication
(10) Pub. No.: US 2026/0274692 A1
(43) Pub. Date: Sep. 17, 2026

(54) METHOD FOR PREPARING MULTIPOD SILICA NANOPARTICLES AND MULTIPOD SILICA NANOPARTICLES

(71) Applicant: INDUSTRY-UNIVERSITY COOPERATION FOUNDATION HANYANG UNIVERSITY ERICA CAMPUS, Ansan-si (KR)

(72) Inventors: Seung Hyun LEE, Ansan-si (KR); Jae Jun PARK, Seoul (KR); Dong Hwan Nam, Seoul (KR); Ha Young KIM, Ansan-si (KR)

(21) Appl. No.: 19/377,766

(22) Filed: Nov. 3, 2025

Related U.S. Application Data
(63) Continuation of application No. PCT/KR2024/014515, filed on Sep. 25, 2024.

(30) Foreign Application Priority Data
Oct. 26, 2023 (KR) 10-2023-0144261
Sep. 12, 2024 (KR) 10-2024-0124356

(51) Int. Cl. C01B 33/18

(52) U.S. Cl. CPC C01B 33/18; C01P 2002/85; C01P 2004/02; C01P 2004/03; C01P 2004/62

(57) ABSTRACT

A one-pot method for producing multipod silica nanoparticles includes the steps of: adding a sodium halide solution to a silica precursor solution; and heat-treating the resulting solution to synthesize silica nanoparticles.

### CROSS-REFERENCE TO RELATED APPLICATION

This application is a bypass continuation of International Application No. PCT/KR2024/014515, filed on Sep. 25, 2024, which claims the benefit of and priority to Korean Patent Application No. 10-2024-0124356, filed on Sep. 12, 2024, and Korean Patent Application No. 10-2023-0144261, filed on Oct. 26, 2023, each filed in the Korean Intellectual Property Office, the disclosures of which are incorporated herein by reference in their entireties.

### TECHNICAL FIELD

The present disclosure relates to a one-pot method for preparing multipod silica nanoparticles, and more particularly, to a method capable of controlling the external morphology and particle size of silica nanoparticles to obtain multipod-shaped silica nanoparticles.

### BACKGROUND ART

Silica nanoparticles are widely utilized owing to their high stability and low toxicity. They have been actively studied in various fields such as drug delivery and catalysis.

In particular, silica nanoparticles have been extensively applied to colloidal and interfacial systems, which is attributable to their excellent particle stability, diverse surface properties, and facile surface modification capability.

Silica nanoparticles having various morphologies are especially suitable for producing specific chemical modifications due to their stability, pore structures, and surface chemistry, and therefore exhibit enhanced efficiency and selectivity compared with other catalysts. These characteristics suggest that silica nanoparticles can be effectively applied in the field of catalysis.

Accordingly, controlling the morphology and pore structures of silica nanoparticles is important for developing catalysts having desired properties, based on the various pores and surface chemistry inherent to the silica nanoparticles. Silica nanoparticles with different morphologies have been utilized as catalysts, and their applications vary depending on their degree of mesoporosity and particle size, which has drawn considerable attention.

Therefore, although various studies have been conducted to control the morphology and pore structures of silica nanoparticles, there remains a need for a one-pot process capable of producing desired surface characteristics and pore structures in a single step.

### DISCLOSURE

### Technical Problem

The technical problem to be solved by the present disclosure is to provide a method for synthesizing silica nanoparticles having a protruded outer morphology by controlling the external shape of the silica nanoparticles through a one-pot process.

### Technical Solution

In order to solve the above-described problem, the present disclosure provides a method for producing multipod silica nanoparticles, comprising the steps of:
adding a sodium halide solution to a silica precursor solution; and
heat-treating the resulting solution to synthesize silica nanoparticles.

In one embodiment, the addition of the sodium halide solution causes a plurality of protrusions to form on the surface of the silica nanoparticles.

In another embodiment, the density of the protrusions formed on the surface of the nanoparticles is determined by the type and amount of the sodium halide solution used.

In one embodiment, the silica precursor is tetraethyl orthosilicate (TEOS).

In another embodiment, the sodium halide is sodium chloride or sodium iodide.

In one embodiment, when the sodium halide is sodium chloride, the density of protrusions formed is higher than when the sodium halide is sodium iodide.

In another embodiment, the size of the multipod silica nanoparticles is controlled by the heat-treatment temperature.

In one embodiment, the number of pods formed on the surface of the multipod silica nanoparticles is from 3 to 7.

In another embodiment, the diameter of the multipod silica nanoparticles is from 300 to 400 nm.

The present disclosure also provides silica nanoparticles having a plurality of pods, wherein 3 to 8 pods are formed on the surface of the silica nanoparticles.

In one embodiment, the diameter of the multipod silica nanoparticles is from 300 to 400 nm, and the nanoparticles are produced by the above-described method.

### BRIEF DESCRIPTION OF DRAWINGS

FIG. 1 is a schematic diagram illustrating the synthesis method according to an embodiment of the present disclosure.

FIGS. 2 and 3 are, respectively, a scanning electron microscope (SEM) image and a particle size analysis result of multipod silica particles synthesized according to one embodiment of the present disclosure.

FIG. 4 is a scanning electron microscope (SEM) image of silica nanoparticles obtained by varying the sodium halide additive used for multipod formation, and

FIG. 5 is a scanning electron microscope (SEM) image showing silica nanoparticles analyzed according to the volume of sodium chloride (NaCl) used.

FIG. 6 is an overall scanning electron microscope (SEM) image of silica nanoparticles obtained in one embodiment of the present disclosure.

FIG. 7 is an enlarged SEM image of multipod silica nanoparticles synthesized according to the present disclosure.

FIG. 8 shows the energy-dispersive X-ray spectroscopy (EDX) analysis results of the multipod silica nanoparticles prepared according to an embodiment of the present disclosure.

FIG. 9 is a photograph of silica nanoparticles produced in Example 3, in which the amount of halide ions was increased.

### BEST MODE

Hereinafter, preferred embodiments of the present disclosure will be described in detail with reference to the accompanying drawings.

Before describing the invention in detail, it should be understood that the terms and words used in this specification are not to be construed as being limited to their ordinary or dictionary meanings. The inventor may appropriately define the concepts of various terms to best explain the invention, and such terms should be interpreted in a meaning and concept consistent with the technical spirit of the invention. In other words, the terms used herein are intended only to describe preferred embodiments of the disclosure, not to limit the scope thereof. These terms are defined in view of the various possibilities of the disclosure.

To solve the above-described problems, the present disclosure synthesizes silica nanoparticles having a multipod structure by using sodium chloride or sodium iodide. Among these, sodium chloride provides the advantage that more protrusions (pods) are formed on the silica surface, enabling application to diverse surface chemistries.

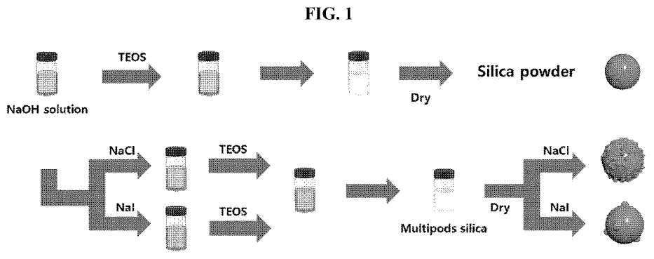

In this specification, the term “multipod” means that two or more protrusions or bulges (pods) are formed on the surface of a nanoparticle, as illustrated in FIG. 1. In the case of silica nanoparticles prepared according to one embodiment of the present disclosure, the surface has 5±1.61 pods.

In addition, the term “one-pot” refers to a process in which the final product is generated from starting materials in a single reaction vessel.

The invention has found, in particular, that the density of protrusions formed on the surface of silica nanoparticles varies depending on the type of sodium halide (NaX, X=halogen) added when using silica nanoparticles. For example, when sodium iodide (NaI) is used, fewer protrusions are formed compared with sodium chloride (NaCl). Thus, by appropriately controlling the type and concentration of the additive, the surface can be tailored to a desired state. In addition, depending on the amount of the additive, the extent to which the particles disperse or aggregate also changes, allowing control over particle morphology. The following Examples and Experimental Examples describe these aspects in greater detail.

### EXAMPLES

### Example 1

A 1 M sodium hydroxide solution was prepared and then diluted to 18 mM using ethyl alcohol and triple-distilled water mixed at a 1:1 ratio. A 9.8 mL portion of the diluted solution was placed in a 20 mL glass vial, and a 1 M sodium chloride solution was prepared as an additive for forming multipods. Subsequently, 0.1 mL of the sodium chloride solution was added to the 18 mM sodium hydroxide solution, stirred thoroughly, and then 0.2 mL of the silica precursor tetraethyl orthosilicate (TEOS) was added. The mixture was stirred for 30 minutes in a water bath maintained at 40° C. After the reaction, the suspension was centrifuged at 6,000 rpm for 10 minutes to stop the reaction, and the precipitate was redispersed in 10 mL of ethyl alcohol. This process was repeated three times. Finally, the sample was redispersed in 3 mL of ethyl alcohol and dried in an oven at 60° C. for at least 24 hours to obtain powdered multipod silica nanoparticles.

### Example 2

A 1 M sodium hydroxide solution was prepared and diluted to 18 mM using a 1:1 mixture of ethyl alcohol and triple-distilled water. A 9.8 mL portion was placed in a 20 mL glass vial, and a 1 M sodium chloride solution was prepared as an additive for forming multipods. Subsequently, 0.1 mL of different sodium halides-sodium iodide (NaI), sodium bromide (NaBr), and sodium fluoride (NaF)—were respectively added to separate 18 mM sodium hydroxide solutions, stirred thoroughly, and then 0.2 mL of TEOS was added. Each solution was stirred for 30 minutes in a 40° C. water bath. Afterwards, centrifugation was carried out at 6,000 rpm for 10 minutes to stop the reaction, and the precipitate was redispersed in 10 mL of ethyl alcohol. This procedure was repeated three times. The final products were dispersed in 3 mL of ethyl alcohol and dried in an oven at 60° C. for at least 24 hours to yield multipod silica nanoparticle powders.

### Example 3

A 1 M sodium hydroxide solution was prepared and diluted to 18 mM with ethyl alcohol and triple-distilled water mixed at a 1:1 ratio. A 9.8 mL aliquot was placed in a 20 mL glass vial, and a 1 M sodium chloride solution was prepared as an additive for multipod formation. Then, 0.1 mL of the sodium chloride solution was added to the 18 mM sodium hydroxide solution, stirred thoroughly, and 0.2 mL of TEOS was added. The solution was stirred for 30 minutes in water baths maintained at different temperatures: room temperature, 40° C., 50° C., and 60° C. The suspension was centrifuged at 6,000 rpm for 10 minutes to stop the reaction, and the resulting precipitate was redispersed in 10 mL of ethyl alcohol. The process was repeated three times. Finally, the product was redispersed in 3 mL of ethyl alcohol and dried in an oven at 60° C. for at least 24 hours to obtain powdered multipod silica nanoparticles.

### Example 4

A 1 M sodium hydroxide solution was prepared and diluted to 18 mM using a 1:1 mixture of ethyl alcohol and triple-distilled water. A 9.8 mL portion was placed in a 20 mL glass vial, and a 1 M sodium chloride solution was prepared as the additive for forming multipods. Then, 0.01 mL, 0.1 mL, and 1 mL of the sodium chloride solution were respectively added to the 18 mM sodium hydroxide solutions, stirred thoroughly, and 0.2 mL of TEOS was added. The mixture was stirred for 30 minutes in a 40° C. water bath. After centrifugation at 6,000 rpm for 10 minutes to stop the reaction, the precipitate was redispersed in 10 mL of ethyl alcohol. This step was repeated three times. Finally, the sample was redispersed in 3 mL of ethyl alcohol and dried in an oven at 60° C. for at least 24 hours to obtain multipod silica nanoparticle powders.

### Comparative Example

As a comparative example, sodium chloride was not added, and ordinary silica nanoparticles were synthesized. Specifically, a 1 M sodium hydroxide solution was prepared and diluted to 18 mM using a 1:1 mixture of ethyl alcohol and triple-distilled water. A 9.8 mL aliquot was placed in a 20 mL glass vial, and 0.2 mL of TEOS was added after thorough mixing. The mixture was stirred for 30 minutes, centrifuged at 6,000 rpm for 10 minutes to stop the reaction, and the precipitate was redispersed in 10 mL of ethyl alcohol. The process was repeated three times. The final product was redispersed in 3 mL of ethyl alcohol and dried in an oven at 60° C. for at least 24 hours to obtain silica nanoparticle powder.

FIG. 1 is a schematic diagram of the synthesis process according to an embodiment of the present disclosure.

Referring to FIG. 1, multipod silica nanoparticles were synthesized using sodium chloride in the silica nanoparticle synthesis process. In the general synthesis of silica nanoparticles (see the upper process in FIG. 1 and the comparative example), sodium chloride is not used. However, to form a multipod structure, it is essential to add an appropriate sodium halide compound, as shown in the lower process of FIG. 1.

### Experimental Example

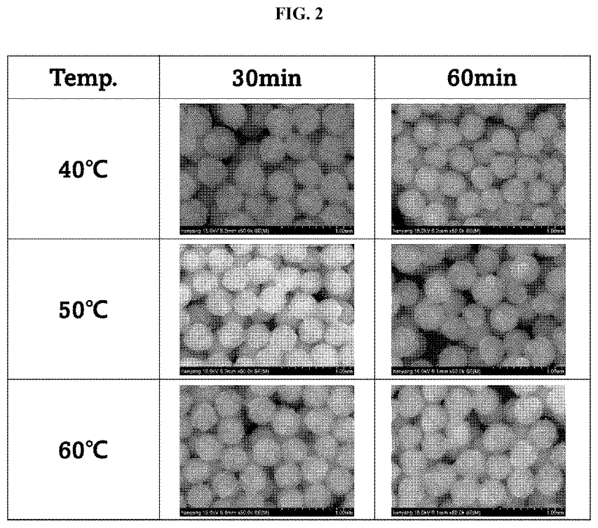

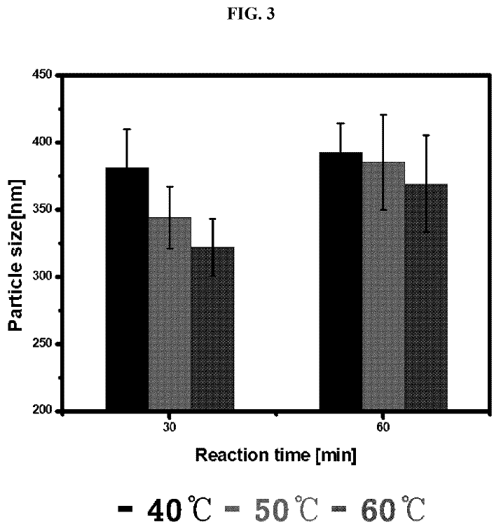

FIGS. 2 and 3 are respectively SEM images and particle size analysis results of multipod silica particles synthesized according to an embodiment of the present disclosure.

Referring to FIGS. 2 and 3, as the reaction temperature increases, the particle size decreases, and this decrease becomes more pronounced when the reaction time is shorter.

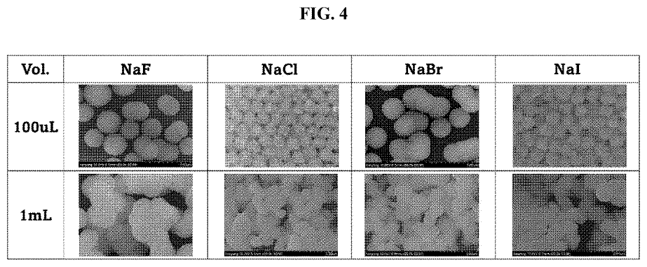

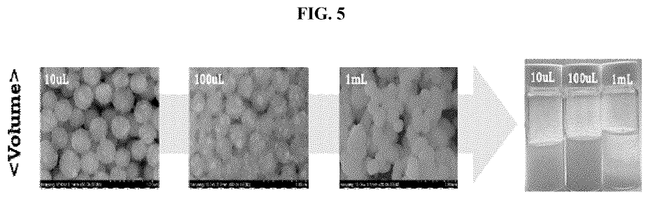

FIG. 4 shows SEM images of silica nanoparticles obtained using different sodium halides as additives for multipod formation, and FIG. 5 shows SEM images of silica nanoparticles analyzed according to the volume of sodium chloride (NaCl) used.

Referring to FIG. 4, when sodium chloride (NaCl) is used, denser pod structures are formed compared with sodium iodide (NaI). Referring to FIG. 5, the amount of sodium chloride (NaCl) determines whether distinct multipod particles or aggregated multipod structures are formed.

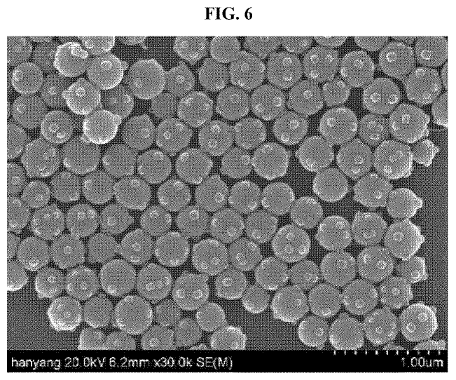

FIG. 6 is an overall scanning electron microscope (SEM) image of the silica nanoparticles obtained in one embodiment of the present disclosure.

Referring to FIG. 6, it can be seen that silica nanoparticles having an overall spherical shape and multiple protrusions on their surfaces were successfully formed.

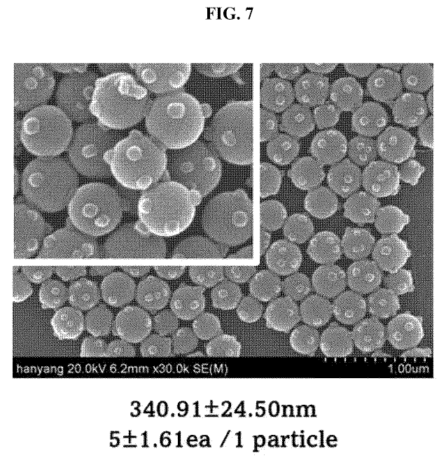

FIG. 7 is an enlarged SEM image of the multipod silica nanoparticles synthesized according to the present disclosure.

Referring to FIG. 7, in the case of the multipod silica nanoparticles produced in this embodiment of the present disclosure, the average diameter of the spherical core particles was 340.91 nm±24.50 nm, and the number of pods attached to each particle was 5±1.61. That is, the present disclosure provides silica nanoparticles having at least three or more, preferably three to eight, protrusions (pods) on the surface of each silica nanoparticle, thereby offering a larger reactive surface area compared with conventional spherical silica nanoparticles. Furthermore, the disclosure provides uniform silica nanoparticles having a particle diameter in the range of 300 to 400 nm.

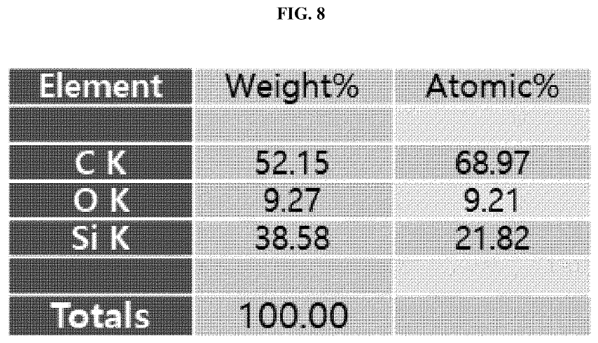

FIG. 8 shows the energy-dispersive X-ray spectroscopy (EDX) analysis results of the multipod silica nanoparticles prepared according to an embodiment of the present disclosure.

Referring to FIG. 8, even when both the entire particles (including the multipods and the network) and the pod regions alone were measured by EDX, only SiO signals were detected, confirming that the silica nanoparticles according to the present disclosure are composed entirely of silica, including the pod structures.

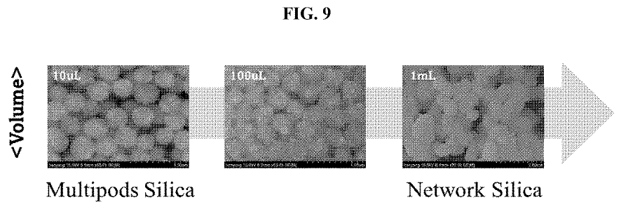

FIG. 9 is a photograph of the silica nanoparticles produced in Example 3, in which the amount of halide ions was increased.

Referring to FIG. 9, regardless of the type of ion, when the amount of halide ions increases, network-type silica particles are formed. Specifically, at halide volumes of 10 μL and 100 μL, multipods are formed on the surface of the silica nanoparticles, whereas when an excessive amount (1 mL) is used, multipod formation does not occur. In addition, under the conditions where multipods are synthesized, it can be observed that small protrusions are also present on the networked silica particles. Here, “networked silica” refers to a state in which spherical silica particles are randomly interconnected.

As described above, the present disclosure provides the advantage that the structure of silica nanoparticles can be tuned to a desired morphology depending on the type of halide ion and the temperature used in the synthesis of multipod silica nanoparticles. Moreover, since the nanoparticles can be synthesized through a one-pot process, the method is economical and efficient. Therefore, the disclosure enables the cost-effective production of nanoparticles having diverse surface-chemical properties, which can serve as functional materials for a variety of applications. Furthermore, the silica nanoparticles of the present disclosure have three to eight pods on each surface, and both the density and number of pods can be controlled by adjusting the process conditions, providing additional versatility.

### Acknowledgment

The present disclosure was derived from the results of a research project titled “Development of Catalyst Materials for Water Electrolysis Based on Carbon and Inorganic Metal Hybrid Nanostructures (University)”, supported by the Gyeonggi Regional Research Center (GRRC) Program.
Project Identification No.: GRRCHanynag2020-B03
Research Program: Gyeonggi Regional Research Center (GRRC)/Basic Project
Host Institution: Gyeonggi Regional Research Center
Funding Agency: Gyeonggi Provincial Government
Research Period: Jul. 1, 2023-Jun. 30, 2024

### INDUSTRIAL APPLICABILITY

The present disclosure relates to a method for producing multipod silica nanoparticles and the multipod silica nanoparticles themselves, which have industrial applicability.

1. A method for producing multipod silica nanoparticles, comprising:
adding a sodium halide to a silica precursor solution; and heat-treating the solution to synthesize the multipod silica nanoparticles.

2. The method of claim 1, wherein a plurality of protrusions are formed on a surface of the multipod silica nanoparticles by the sodium halide.

3. The method of claim 2, wherein a density of the plurality of protrusions formed is determined according to type and amount of the sodium halide.

4. The method of claim 1, wherein a silica precursor is tetraethyl orthosilicate (TEOS).

5. The method of claim 3, wherein the sodium halide is sodium chloride or sodium iodide.

6. The method of claim 5, wherein when the sodium halide is the sodium chloride, the density of the plurality of protrusions formed is higher than when the sodium halide is the sodium iodide.

7. The method of claim 1, wherein a size of the multipod silica nanoparticles is controlled by heat-treatment temperature.

8. The method of claim 1, wherein the number of pods formed on a surface of the multipod silica nanoparticles is from 3 to 7.

9. The method of claim 8, wherein a diameter of the multipod silica nanoparticles is from 300 to 400 nm.
